(19) United States
(12) Patent Application Publication
(10) Pub. No.: US 2013/0044978 A1
(43) Pub. Date: Feb. 21, 2013

(54) Method And System For A Multi-Core Fiber Connector

(71) Applicants: Peter DeDobbelaere, San Diego, CA (US); Mark Peterson, San Diego, CA (US); Steffen Gloeckner, San Diego, CA (US)

(72) Inventors: Peter DeDobbelaere, San Diego, CA (US); Mark Peterson, San Diego, CA (US); Steffen Gloeckner, San Diego, CA (US)

(21) Appl. No.: 13/535,320

(22) Filed: Jun. 27, 2012

Related U.S. Application Data
(60) Provisional application No. 61/575,517, filed on Aug. 20, 2011.

(51) Int. Cl. G02B 6/32

(52) U.S. Cl. 385/33

(57) ABSTRACT

Methods and systems for a multi-core fiber connector are disclosed and may include communicating optical signals in a fiber comprising a multi-core. The connectors may comprise dimensions to fit one or more of: SC, LC, FC, or MU connectors. The optical signals may be collimated utilizing a lens in the connectors, and may comprise a graded-index (GRIN) lens or a ball lens. The connectors may comprise a ferrule assembly that encompasses an end of the optical fiber and is at least partially within a stem assembly. The ferrule assembly may comprise zirconia and the stem assembly may comprise stainless steel. The lens may be fixed adjacent to the ferrule assembly utilizing a stainless steel tube. The collimated optical signals may be communicated to a receiving lens that may focus the collimated optical signals onto a plurality of optical cores in a receiving optical fiber.

### CROSS-REFERENCE TO RELATED APPLICATIONS/INCORPORATION BY REFERENCE

This application claims priority to U.S. Provisional Application 61/575,517, filed on Aug. 20, 2011, each of which is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to fiber optics. More specifically, certain embodiments of the invention relate to a method and system for a multi-core fiber connector.

### BACKGROUND OF THE INVENTION

As data networks scale to meet ever-increasing bandwidth requirements, the shortcomings of copper data channels are becoming apparent. Signal attenuation and crosstalk due to radiated electromagnetic energy are the main impediments encountered by designers of such systems. They can be mitigated to some extent with equalization, coding, and shielding, but these techniques require considerable power, complexity, and cable bulk penalties while offering only modest improvements in reach and very limited scalability. Free of such channel limitations, optical communication has been recognized as the successor to copper links.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a multi-core fiber connector, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating fiber optic communication utilizing multi-core fiber connectors, in accordance with an embodiment of the invention.

FIGS. 2A-2C is a schematic illustrating various views of an exemplary multi-core connector ferrule and stem, in accordance with an embodiment of the invention.

FIGS. 3A-3C is a schematic illustrating various views of exemplary multi-core connector stem, ferrule, and lens assemblies, in accordance with an embodiment of the invention.

FIG. 4 is a schematic illustrating an exemplary spring and crimp sleeve, in accordance with an embodiment of the invention.

FIG. 5 is a diagram illustrating an exemplary multi-core connector inner housing, in accordance with an embodiment of the invention.

FIG. 6 is a diagram illustrating an exemplary multi-core fiber interconnect, in accordance with an embodiment of the invention.

FIG. 7 is a diagram illustrating an exemplary interconnect between multi-core fiber connectors, in accordance with an embodiment of the invention.

FIG. 8 is a diagram illustrating the communication of optical beams between multi-core fiber connectors, in accordance with an embodiment of the invention.

FIG. 9 is a diagram illustrating optical beams from a multi-core connector, in accordance with an embodiment of the invention.

FIG. 10 is a diagram illustrating optical beams from a multi-core fiber, in accordance with an embodiment of the invention.

### DETAILED DESCRIPTION OF THE INVENTION

Certain aspects of the invention may be found in a method and system for a multi-core fiber connector. Exemplary aspects of the invention may comprise communicating optical signals in a fiber comprising a plurality of fiber cores and one or more connectors. The optical signals may be collimated utilizing a lens in the one or more connectors. The connectors may have dimensions to fit one or more of: standard connector (SC), fiber channel (FC), and/or Lucent connector (LC) connector assemblies. The lens may comprise a graded-index (GRIN) lens, an aspheric lens, or a ball lens. Each of the one or more connectors may comprise a ferrule assembly that encompasses an end of the optical fiber and is at least partially within a stem assembly. The ferrule assembly may comprise zirconia and the stem assembly may comprise stainless steel. The plurality of fiber cores may be aligned utilizing an alignment notch in the stem assembly. The lens may be fixed adjacent to the ferrule assembly utilizing a stainless steel tube. The collimated optical signals may be communicated to a receiving lens that may focus the collimated optical signals onto a plurality of optical cores in a receiving optical fiber.

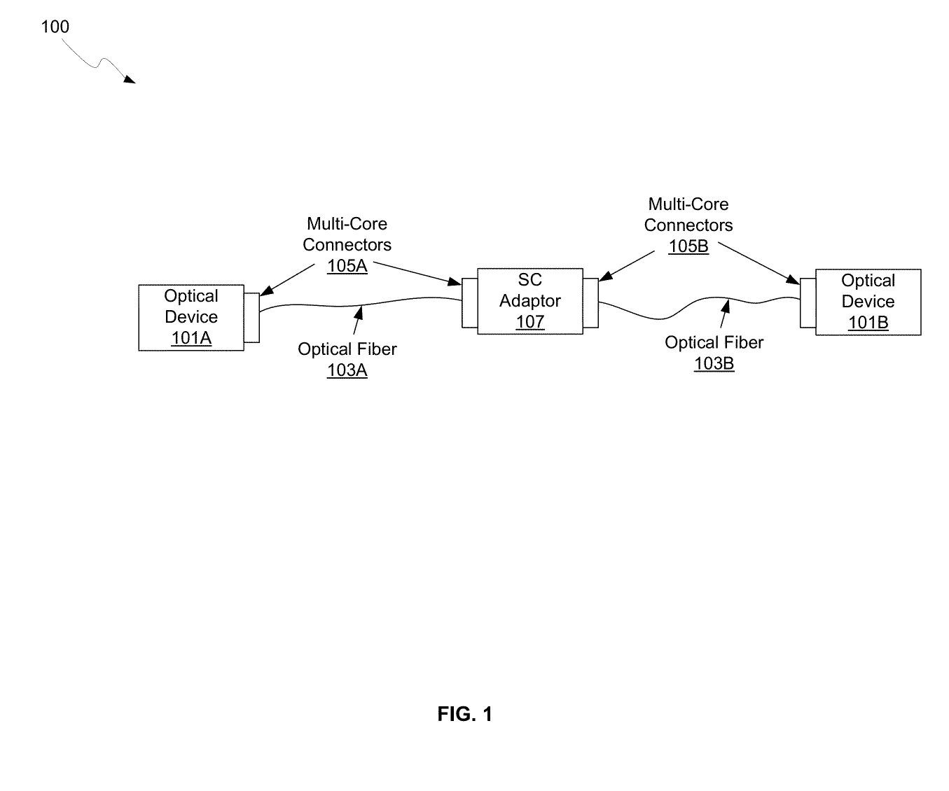

FIG. 1 is a diagram illustrating fiber optic communication utilizing multi-core fiber connectors, in accordance with an embodiment of the invention. Referring to FIG. 1, there is shown a fiber optic network 100 comprising optical devices 101A and 101B, optical fibers 103A and 103B, fiber connectors 105A and 105B, and a standard fiber optic connector (SC) adaptor 107.

The optical devices 101A and 101B comprise any device that is operable to communicate via optical signals for data communication or telecommunications applications. For example, the optical devices 101A and 101B may comprise optical transceivers integrated in servers for communicating data between racks of servers. Accordingly, the optical device 101A may generate optical signals from electrical signals, with the electrical signals either generated within the optical device 101A or received from another device or server.

The optical device 101A may then communicate the optical signals over the optical fibers 103A and 103B to the optical device 101B. The optical devices 101A and 101B may comprise ports for receiving industry-standard fiber optic connectors, such as SC connectors, which may also be known as “Seiko connectors,” “subscriber connectors,” “set and click,” “stab and click,” and/or “square connectors,” hereinafter referred to as SC connectors. Furthermore, the connectors may conform to any desired connector types, such as LC, FC, MU, multi-fiber, and array-type connectors. While FIGS. 1-10 illustrate connectors with SC connector dimensions, the invention is not so limited. Accordingly, any connector type or dimensions may be utilized.

The optical fibers 103A and 103B may comprise multiple single-mode or multi-mode cores in a single fiber for communicating a plurality of optical signals. For example, the optical fibers 103A and 103B may comprise an outer dimension of ˜200 micron diameter and eight cores of ˜9 micron diameter arranged in two rows of four cores. In an exemplary scenario, connectors may be affixed to each end of the multi-core fibers that conform to SC connector dimensions, thereby allowing multi-core fiber communications through a single SC connector.

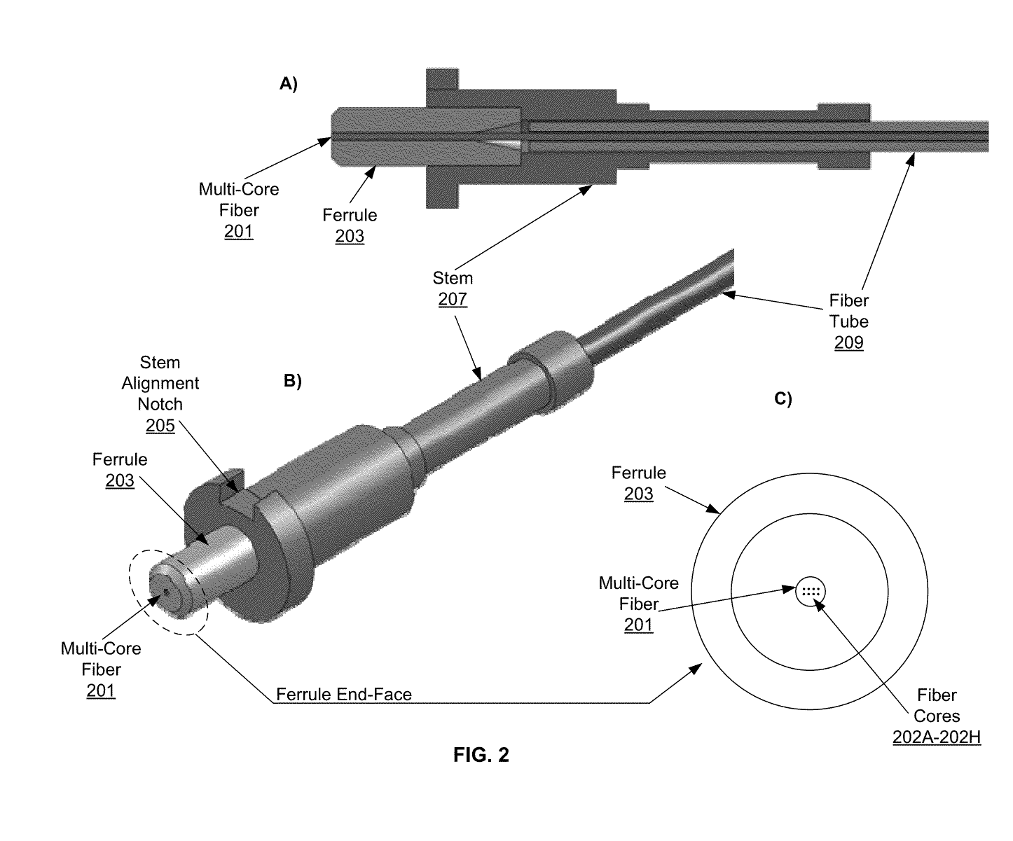

The multi-core connectors 105A and 105B may comprise connectors at each end of the optical fibers 103A and 103B that may couple to standard interconnects, while supporting multiple core fibers. The multi-core connectors 105A and 105B may comprise a lens to reduce alignment sensitivity and to reduce the impact of contamination on light coupling. In addition, the multi-core connectors 105A and 105B may comprise alignment features to ensure the signals received from the cores of the multi-core fiber align with a receiving fiber or device. The multi-core connectors 105A and 105B are described further with respect to FIGS. 2-10.

The SC adaptor 107 may comprise an interconnect for coupling two SC connectors, such as the multi-core connectors 105A and 105B. The SC adaptor 107 may thus comprise receiving port assemblies and may enable the coupling of multiple optical fibers, without the need for splicing.

In operation, the optical devices 101A and 101B may communicate optical signals via the optical fibers 103A and 103B, with signals being communicated in a plurality of optical cores in the optical fibers 103A and 103B. The multi-core connectors 105A and 105B may enable the alignment of the cores at each end so that optical signals may be communicated from a core in one optical fiber to a corresponding core in another optical fiber. The multi-core connectors 105A and 105B may comprise lenses and alignment features to ensure the alignment of the optical signals with the appropriate receiving fiber cores.

FIGS. 2A-2C is a schematic illustrating various views of an exemplary multi-core connector ferrule and stem, in accordance with an embodiment of the invention. FIG. 2A) illustrates a cross-sectional view, FIG. 2B) illustrates an oblique angle view, and FIG. 2C) illustrates an end view of the front face, all of the ferrule 203 and the multi-core fiber 201. Referring to FIGS. 2A-2C, there are shown internal components of the multi-core connectors 105A and 105B, comprising a multi-core fiber 201, a ferrule 203, a stem alignment notch 205, a stem assembly 207, and a fiber tube 209.

The multi-core fiber 201 may be similar to the optical fibers 103A and 103B and may comprise multiple optical cores, fiber cores 202A-202H, each capable of propagating optical signals. In an exemplary scenario, the multi-core fiber 201 may comprise eight cores of approximately 200 microns in diameter, arranged in two rows of four cores, as illustrated by the fiber cores 202A-202H in FIG. 2C). However, it should be noted that the invention is not necessarily so limited. Accordingly, any arrangement of cores within the multi-core fiber 201 may be utilized based on the available diameter, total desired bandwidth, and preferences for single-mode or multi-mode fibers.

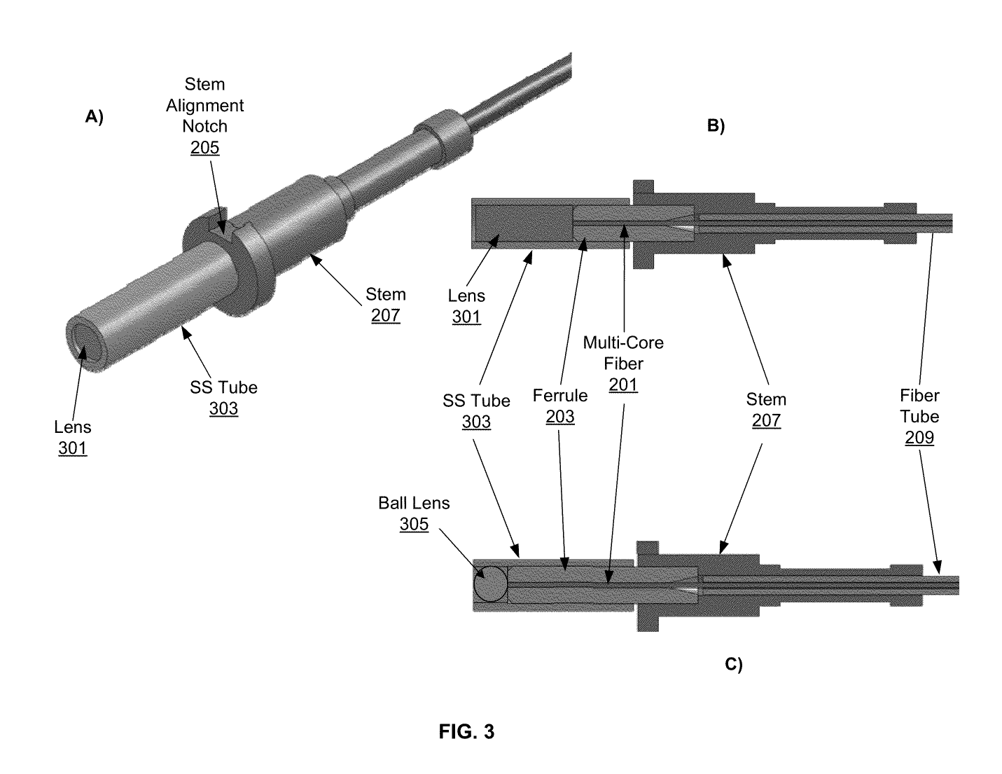

The ferrule assembly 203 may comprise a zirconia material, for example, and may secure the multi-fiber core 201 within the stem assembly 207 and the multi-core connectors 105A and 105B, while also providing a front face for the multi-core fiber 201. The ferrule assembly 203 may be secured within the stem assembly 207 to provide mechanical support, and extend out far enough to enable mechanical coupling to a lens, as illustrated in FIGS. 3-10.

In an exemplary scenario, the ferrule assembly 203 may be 1-2 mm in diameter with an optional angle polish, which may be utilized depending on the return loss requirements for the fiber optic communications. The ferrule assembly 203 may comprise dimensions such that it may be utilized in a connector housing assembly that comprises dimensions of a SC connector assembly, i.e. may fit into a SC connector port.

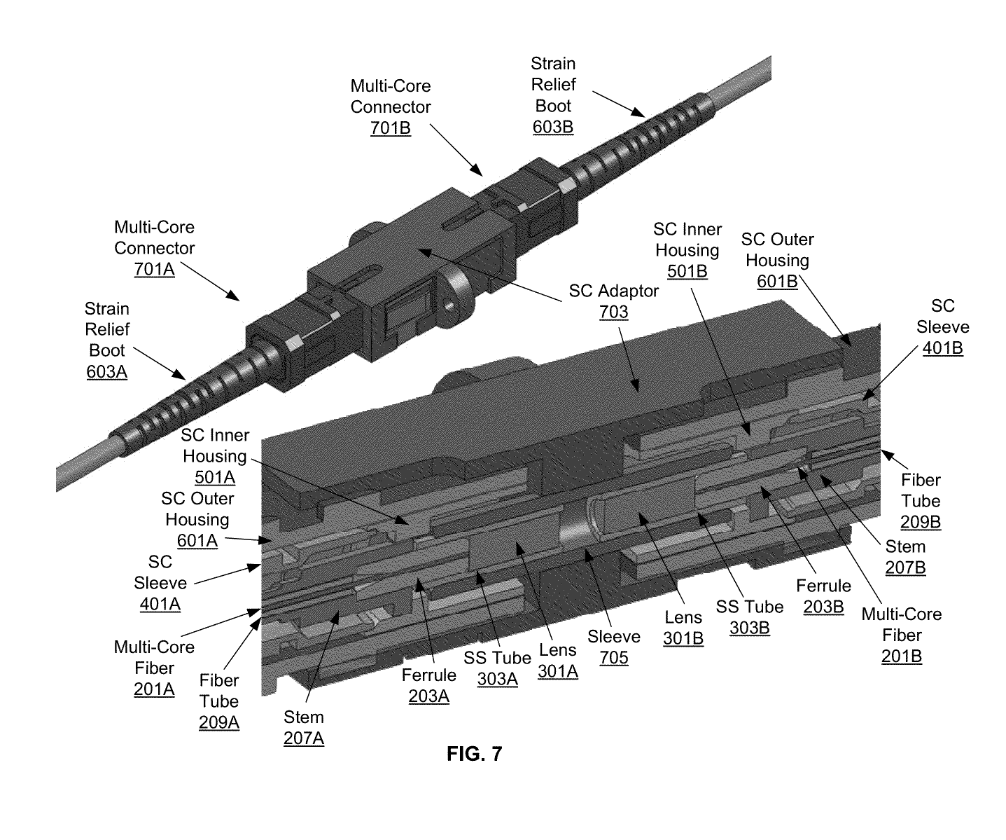

The stem assembly 207 may comprise a metal tubular structure for securing the multi-core fiber 201 and the ferrule assembly 203 in the multi-core connectors 105A and 105B. In an exemplary embodiment, the stem assembly 207 may comprise stainless steel. In addition, the stem assembly 207 may comprise the stem alignment notch 205 to enable alignment of the fiber with another fiber or device. For example, in instances where the multiple cores in the multi-core fiber 201 have an axial or biaxial alignment, such as the two rows of the fiber cores 202A-202H shown in FIG. 2C), the stem alignment notch 205 and a key in a housing enclosing the stem assembly 207 may ensure that the core axis is fixed. Accordingly, this axial alignment may enable the optical signals from each of the fiber cores 202A-202H to align with the cores in another multi-core fiber coupled to the multi-core fiber 201, as illustrated in FIGS. 7-10.

The fiber tube 209 may comprise a flexible material for covering the multi-core fiber 201, which may run the length of the fiber into the stem assembly 207 and up to the ferrule 203, as shown in FIG. 2A). In an exemplary scenario, the fiber tube 209 may be ˜1 mm in diameter.

FIGS. 3A-3C is a schematic illustrating various views of exemplary multi-core connector stem, ferrule, and lens assemblies, in accordance with an embodiment of the invention. Referring to FIGS. 3A-3C, there are shown internal elements of the multi-core connectors 105A and 105B, comprising the multi-core fiber 201, the ferrule 203, the stem alignment notch 205, the stem assembly 207, the fiber tube 209, a lens 301, a stainless steel tube 303, and a ball lens 305.

The lens 301 may comprise a graded index (GRIN) lens, where the gradual variation in the index of refraction enables a flat front surface and reduces aberrations. The flat front surface is illustrated in FIGS. 3A) and 3B). In an exemplary scenario, the lens 301 may be ˜1.8 mm in diameter with a length of ˜5 mm. The lens 301 may collimate optical signals from the multi-core fiber 201 that may then be focused onto associated cores of a receiving multi-core fiber, or other receiving devices, utilizing a receiving lens. Similarly, the lens 301 may receive optical signals from external sources and focus them onto desired cores of the multi-core fiber 201. In an alternative embodiment, a ball lens 305 may be utilized instead of a GRIN lens, as illustrated in FIG. 3C.

The stainless steel tube 303 may be operable to provide mechanical support for the ferrule assembly 203 and the lens 301/305, with the outer dimensions of the stainless steel tube 303 and the stem assembly 207 configured to match a standard SC ferrule assembly, enabling multi-core fiber integration with SC connectors. In an exemplary scenario, the stainless tube 303 may be ˜2.5 mm in diameter, and may extend just beyond the end of the lens 301/305 to protect the end face of the lens 301 or the ball lens 305. The stainless steel tube 303 may be epoxied, for example, to the lens 301 and the ferrule assembly 203.

The ball lens 305 may comprise a spherical lens that is operable to focus a plurality of optical signals from the multi-core fiber 201. Ball lenses are capable of focusing or collimating optical signals, depending on the geometry of the source. In this instance, with multiple core optical sources, the ball lens 305 may collimate optical signals from the multi-core fiber 201 that may then be focused onto associated cores of a receiving multi-core fiber, or other receiving devices, utilizing a receiving lens. Similarly, the ball lens 305 may receive optical signals from external sources and focus them onto desired cores of the multi-core fiber 201.

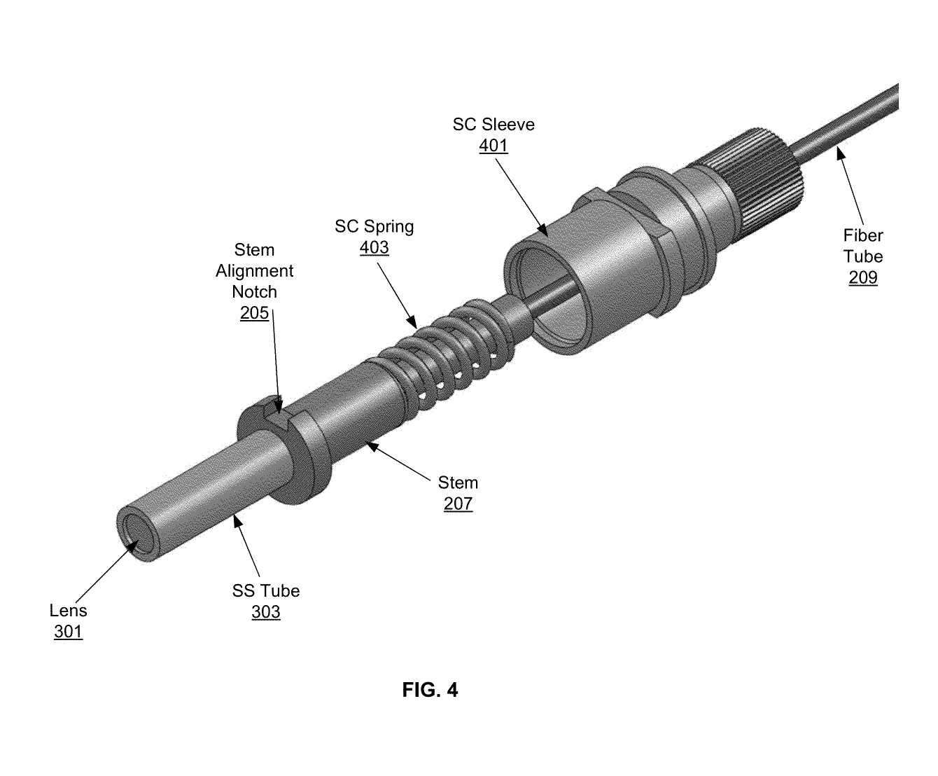

FIG. 4 is a schematic illustrating an exemplary spring and crimp sleeve, in accordance with an embodiment of the invention. Referring to FIG. 4, there is shown the stem alignment notch 205, the stem assembly 207, the fiber tube 209, the lens 301, the stainless steel tube 303, a SC sleeve 401, and a SC spring 403.

The SC sleeve 401 may comprise stainless steel and may provide a housing for the stem assembly 207 and a surface against which the SC spring 403 may apply force to place the stem assembly 207 at a desired position for configuring the spacing between the lens 301 and a receiving structure or assembly. For example, another SC connector with the same lens, stem, and ferrule assemblies may be coupled to the connector comprising the stainless steel tube 303, the lens 301, and the stem 207. By placing the lenses of the coupled connectors at a specific distance, the coupling efficiency may be optimized.

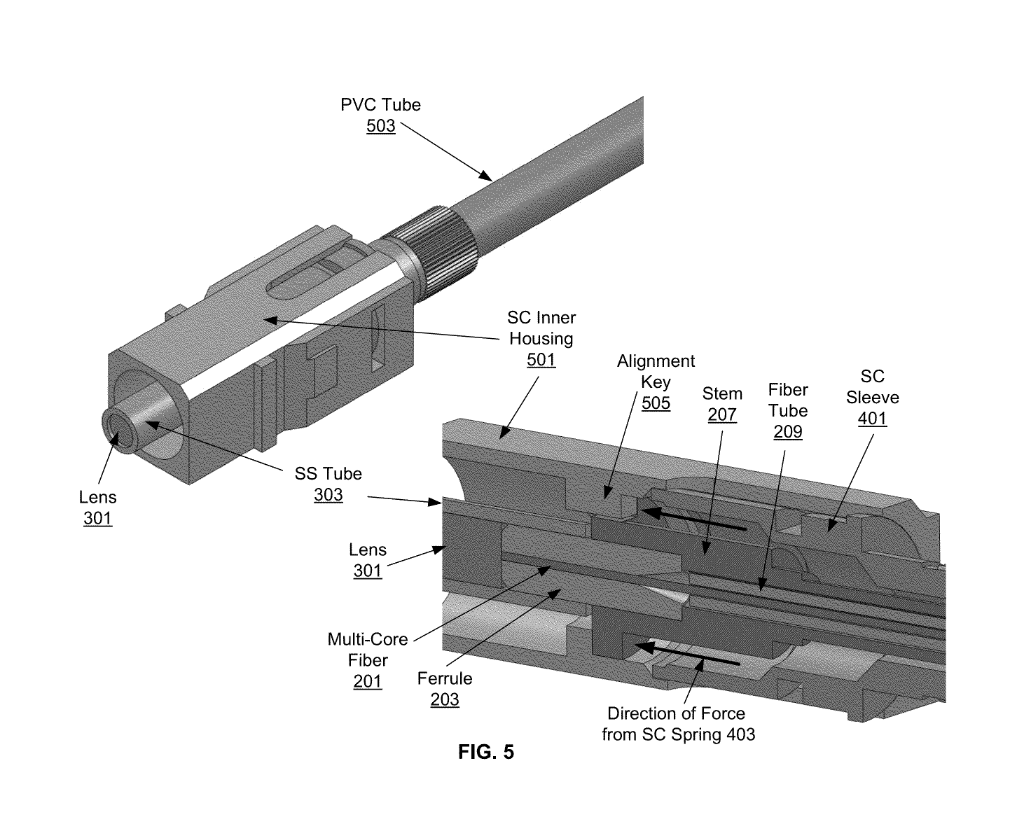

The SC spring 403 may comprise a metal spring that is operable to provide a force to keep the stem assembly 207 and affixed components at a specific position in the multi-core connectors 105A and 105B through compression with an angled surface in the SC sleeve 401, as shown further in FIG. 5.

FIG. 5 is a diagram illustrating an exemplary multi-core connector inner housing, in accordance with an embodiment of the invention. Referring to FIG. 5, there is shown the multi-core fiber 201, the ferrule 203, the stem assembly 207, the fiber tube 209, the lens 301, the stainless steel tube 303, the SC sleeve 401, a SC inner housing 501, a poly-vinyl chloride (PVC) tube 503, and an alignment key 505.

The PVC tube 503 may provide protection for the multi-core fiber 201 from mechanical damage and may provide flexibility without excessive bending of the fibers. The alignment key 505 may enable the alignment of the cores in the multi-core fiber 201 with the receiving fiber or devices. Accordingly, the alignment key 505 may coincide with the stem alignment notch 205 in the stem assembly 207 when the stem assembly 207 is inserted in the SC inner housing 501, such that the fiber cores 201A-201H in the multi-core fiber 201 may only be oriented in a desired direction. This may enable the configuration of the orientation between the cores of both fibers in a fiber-to-fiber interconnect or fiber-to-receiving device connection.

In an exemplary scenario, the SC inner housing 501 may comprise appropriate dimensions, slots, and tabs to fit into SC connector port assemblies. Accordingly, the SC inner housing 501 may fit into an outer housing, which may be operable to fit into a SC receptacle assemblies.

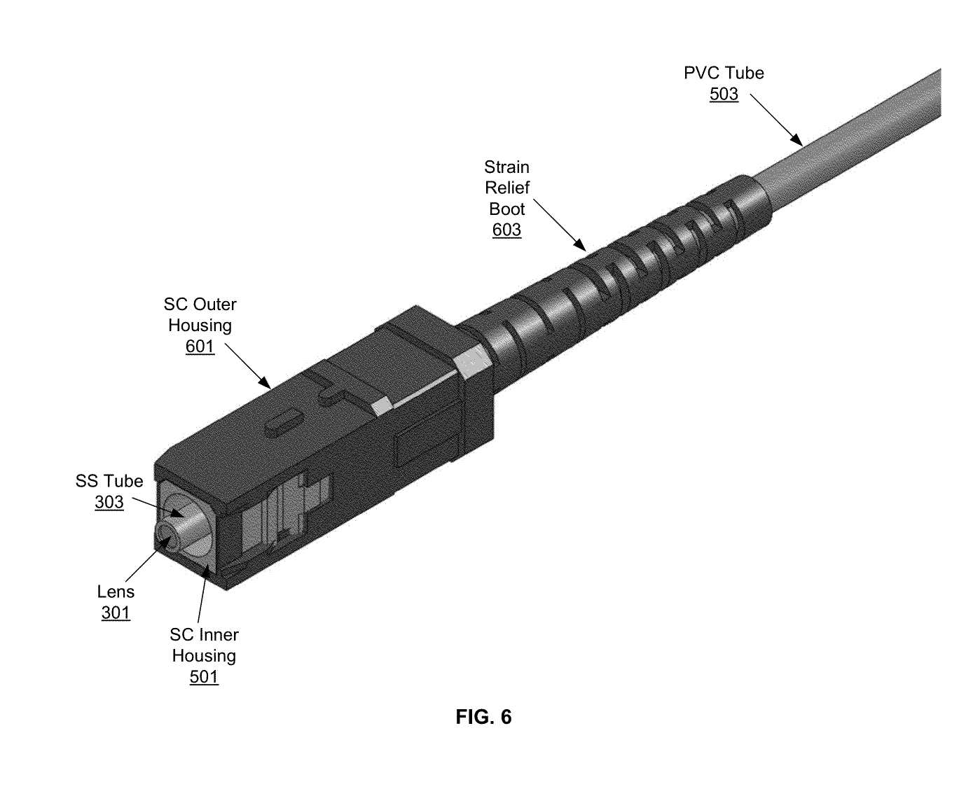

FIG. 6 is a diagram illustrating an exemplary multi-core fiber interconnect, in accordance with an embodiment of the invention. Referring to FIG. 6, there is shown the lens 301, the stainless steel tube 303, the SC inner housing 501, the PVC tube 503, a SC outer housing 601, and a strain relief boot 603.

The SC outer housing 601 comprises a structure for enclosing the entire multi-core interconnect and comprises the strain relief boot 603 for ensuring that excessive bend angles do not occur with the multi-core fiber 201 at the junction with the outer housing 601. The outer dimensions of the SC outer housing 601 may match standard SC connector assembly dimensions, thereby enabling the coupling of multi-core fibers with standard connectors and receptacle port assemblies.

FIG. 7 is a diagram illustrating an exemplary interconnect between multi-core fiber connectors, in accordance with an embodiment of the invention. Referring to FIG. 7, there is shown a multi-core connector 701A comprising the multi-core fiber 201A, the ferrule 203A, the fiber tube 209A, the lens 301A, the stainless steel tube 303A, the SC sleeve 401A, the SC inner housing 501A, the SC outer housing 601A, and the strain relief boot 603A.

There is also shown a similar multi-core connector 701B comprising the multi-core fiber 201B, the ferrule 203B, the fiber tube 209B, the lens 301B, the stainless steel tube 303B, the SC sleeve 401B, the SC inner housing 501B, the SC outer housing 601B, and the strain relief boot 603B. Additionally, there is shown a SC adaptor 703, which may be operable to provide a coupling between the multi-core connectors 701A and 701B. Like-numbered parts in FIG. 7 are as described previously with respect to FIGS. 1-6, but with “A” and “B” added to indicate two of these elements are shown to illustrate the coupling of two multi-core fiber connectors.

The multi-core connectors 701A and 701B may comprise like components, and as such may enable the interconnection of two multi-core fibers that have a rotationally dependent arrangement of fiber cores. The SC adaptor 703 may comprise two ports for receiving SC-type connectors, such as the multi-core connectors 701A and 701B. The SC adaptor 703 may comprise the sleeve 705, which may comprise precision phosphor bronze or zirconia, for example, that may be operable to align the lensed ferrules enclosed by the stainless steel tubes 303A and 303B of the two multi-core connectors 701A and 701B. The gap between the lenses 301A and 301B may thus be controlled by the connector geometry, i.e., the dimensions of the SC inner housings 501A and 501B, the SC outer housings 601A and 601B and the lensed ferrules when plugged into the SC adaptor 703.

In this manner, optical coupling efficiency may be optimized and controlled by the physical dimensions of the connector and the optical properties of the lenses. In an exemplary scenario, optical signals may be communicated to the multi-core connector 701B via the multi-core fiber 201B. The optical signals may exit the fiber at the back surface of the lens 301B and subsequently collimated by the lens 301B. The collimated beams may be received by the lens 301A and focused down to the multiple cores of the multi-core fiber 201B by the lens 301B. The optical signals may then proceed down the multi-core fiber 201A.

This optical communication via the multiple cores of the optical fibers 201A and 201B may proceed in either direction, i.e., from left to right and from right to left.

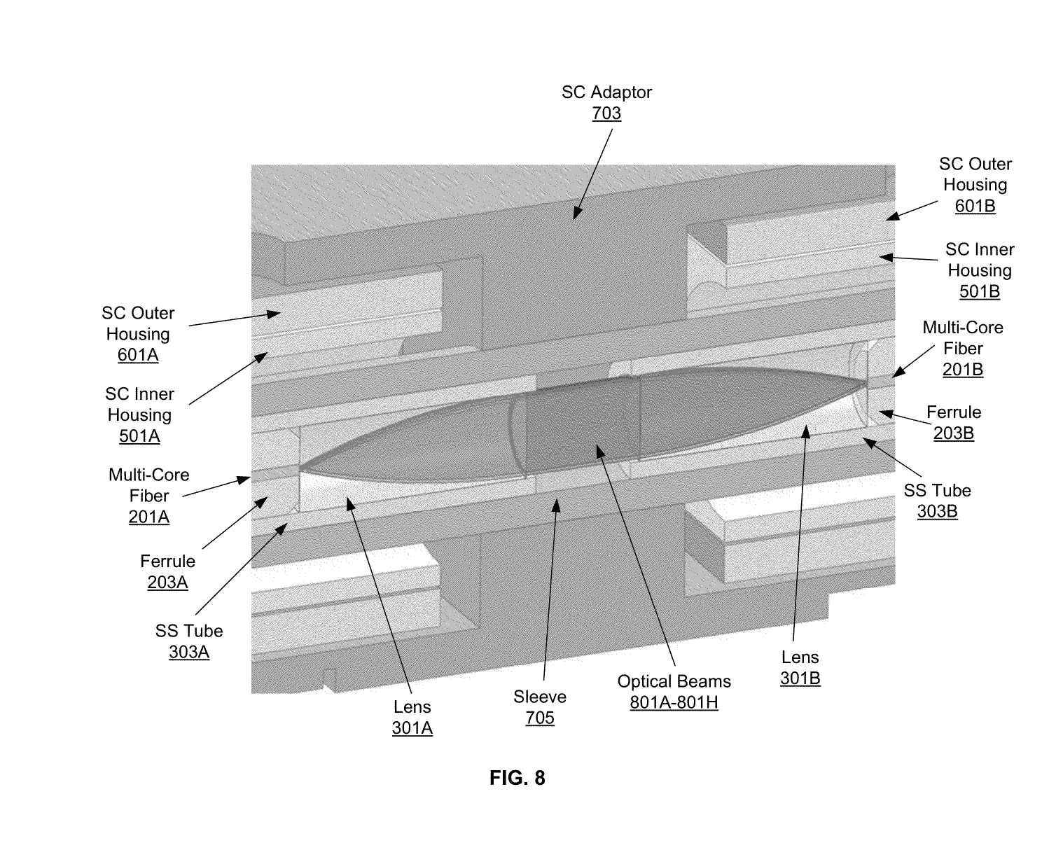

FIG. 8 is a diagram illustrating the communication of optical beams between multi-core fiber connectors, in accordance with an embodiment of the invention. Referring to FIG. 8, there is shown the multi-core fibers 201A and 201B, the ferrules 203A and 203B, the lenses 301A and 301B, the stainless steel tubes 303A and 303B, the SC inner housings 501A and 501B, the SC outer housings 601A and 601B, the SC adaptor 703, the sleeve 705, and optical beams 801A-801H.

The optical beams 801A-801H illustrated in FIG. 8 represent optical signals that result between two multi-core connectors when one of the multi-core fibers 201A or 201B is the source of optical signals and the other fiber is the intended recipient of the signals. For example, each of the cores in the multi-core fiber 201B may carry an optical signal to the front surface of the ferrule 203B. The exiting optical signal may be expanded and collimated by the lens 301B, resulting in collimated beams between the lenses 301A and 301B. Expanded beams enable insensitivity to particles, dust, or other contamination in the gap between the two lenses 301A and 301B. In addition, the geometry results in a low dependency of coupled power on separation distance, eliminating the need for high force mechanical contact between the connectors.

Similarly, each of the cores in the multi-core fiber 201A may carry an optical signal to the front surface of the ferrule 203A. The exiting optical signal may be expanded and collimated by the lens 301A, resulting in collimated beams between the lenses 301A and 301B.

In operation, optical signals may be communicated via one or both of the multi-core fibers 201A and 201B, with optical beams exiting from the multi-core fiber 201A and/or 201B at the front face of the ferrule 203A and/or 203B, where the exiting light may comprise an array of cone-shaped light beams. The optical beams may be collimated by the lens 301A and/or 301B, received by the lens 301B and/or 301A, and then focused onto associated cores in the multi-core fiber 201B and/or 201A. In this manner, communication via multi-core optical fibers with SC connectors may be enabled.

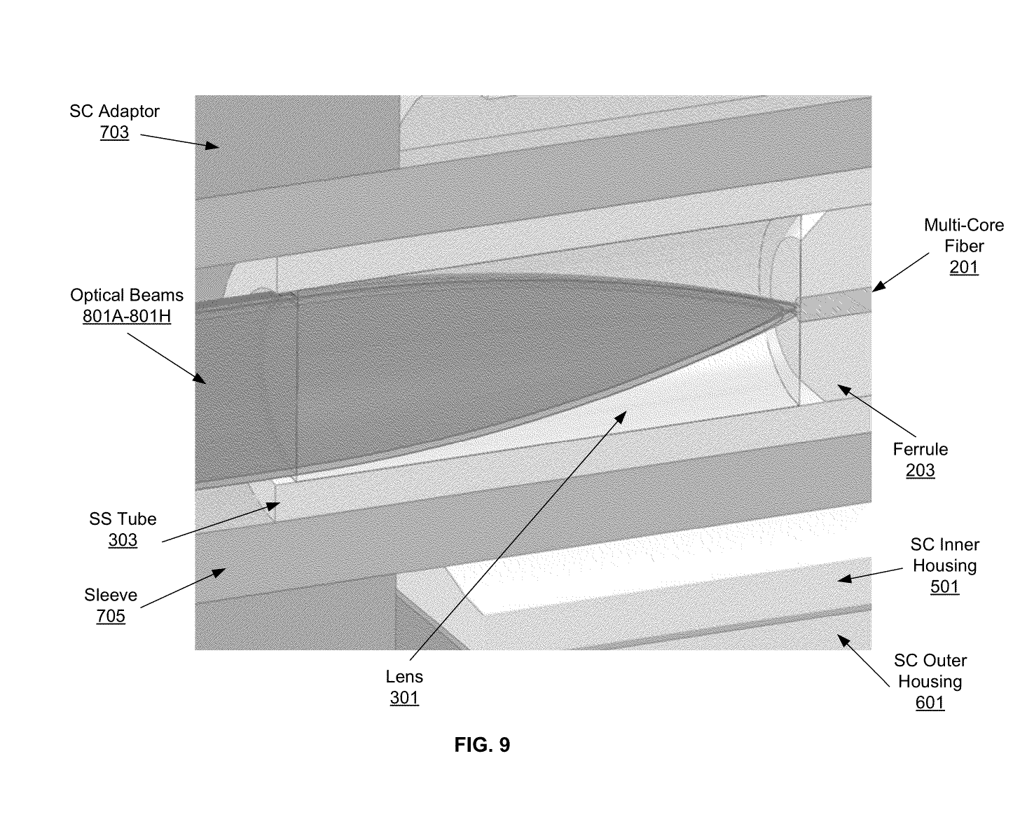

FIG. 9 is a diagram illustrating optical beams from a multi-core connector, in accordance with an embodiment of the invention. Referring to FIG. 9, there is shown the multi-core fiber 201, the ferrule 203, the lens 301, the stainless steel tube 303, the inner housing 501, the SC outer housing 601, the SC adaptor 703, the sleeve 705, and the optical beams 801A-801H.

In an exemplary scenario, optical signals may be communicated via the multi-core fiber 201, and exit the fiber at the front face of the ferrule 203, resulting in cone-shaped beams in the lens 301. The lens 301 may collimate the beams as shown in FIG. 9 by the optical beams 801A-801H. This collimation of each of the optical signals from the multiple cores of the multi-core fiber 201 enables insensitivity to dust or particles and results in a low dependency of coupled power on connector separation distance. A similar lens on the receiving connector or other receiving device may focus the beams back to a plurality of fiber cores or detectors for detection of the individual optical signals, thereby enabling the coupling of multi-core fibers with SC form-factor connectors.

Conversely, the optical beams 801A-801H may be received from a source fiber or optical transmitter, focused onto the multiple cores of the multi-core fiber 201, and communicated along the multi-core fiber 201.

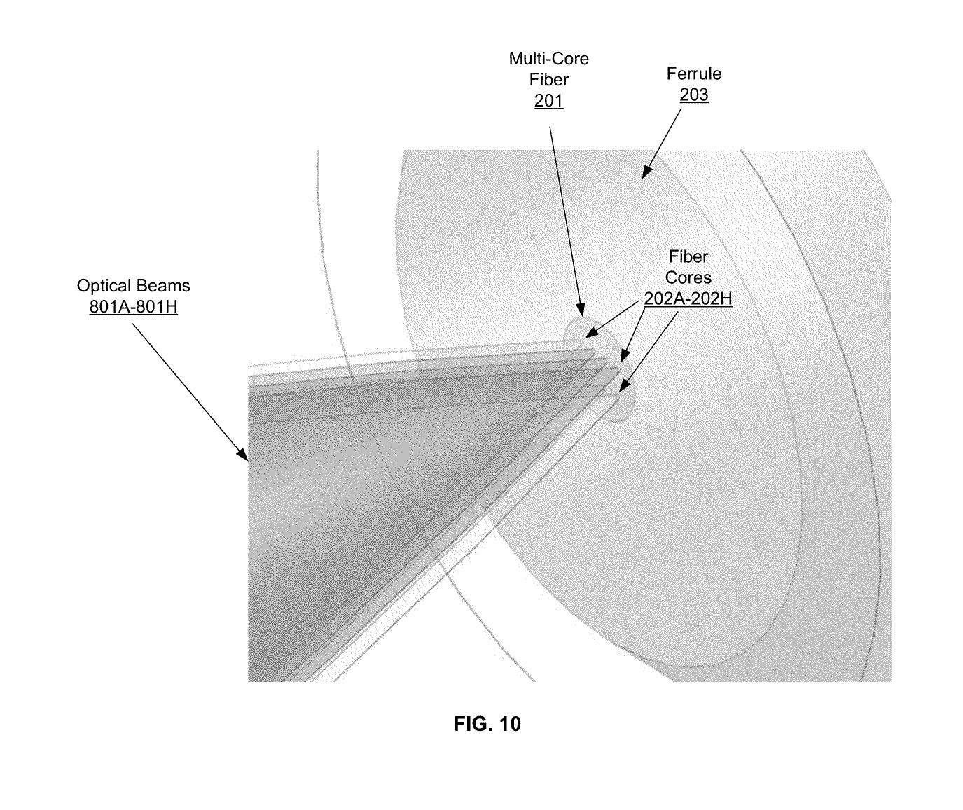

FIG. 10 is a diagram illustrating optical beams from a multi-core fiber, in accordance with an embodiment of the invention. Referring to FIG. 10, there is shown the multi-core fiber 201, the fiber cores 202A-202H, the ferrule 203, and the optical beams 801A-801H.

In an exemplary scenario, optical signals may be communicated via the fiber cores 202A-202H in the multi-core fiber 201, and exit the fiber at the front face of the ferrule 203, resulting in cone-shaped beams. The optical signals may be collimated by a lens, such as the lens 301 or the ball lens 305, for example. Conversely, the optical beams 801A-801H may be received from an external source, such as another multi-core fiber with a multi-core SC connector, and focused by a lens onto the fiber cores 202A-202H, for subsequent communication down the multi-core fiber 201.

In an embodiment of the invention, a method and system are disclosed for a multi-core fiber connector. In this regard, aspects of the invention may comprise communicating optical signals in a fiber 201 comprising a plurality of fiber cores 202A-202H and one or more connectors 105A, 105B, 701A, 701B, where the connectors 105A, 105B, 701A, 701B may have dimensions to fit standard connector (SC) assemblies. The optical signals may be collimated utilizing a lens 301, 305 in the one or more connectors 105A, 105B, 701A, 701B.

The lens 301, 301A, 301B, 305, 305A, 305B may comprise a graded-index (GRIN) lens 301 or a ball lens 305. Each of the one or more connectors 105A, 105B, 701A, 701B may comprise a SC ferrule assembly 203, 203A, 203B that encompasses an end of the optical fiber 201, 201A, 2101B and is at least partially within a stem assembly 207, 207A, 207B. The SC ferrule assembly 203, 203A, 203B may comprise zirconia and the stem assembly 207, 207A, 207B may comprise stainless steel.

The plurality of fiber cores 202A-202H may be aligned utilizing an alignment notch 205 in the stem assembly 207, 207A, 207B. The lens 301, 301A, 301B, 305, 305A, 305B may be fixed adjacent to the SC ferrule assembly 203, 203A, 203B utilizing a stainless steel tube 303, 303A, 303B. The collimated optical signals 801A-801H may be communicated to a receiving lens 301A that may focus the collimated optical signals 801A-801H onto a plurality of optical cores in a receiving optical fiber 201A.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communication, the method comprising:
in an optical fiber comprising a plurality of fiber cores and one or more connectors:
communicating optical signals in said plurality of fiber cores to said one or more connectors; and
collimating said optical signals utilizing a lens in said one or more connectors.

2. The method according to claim 1, wherein said one or more connectors comprise dimensions to fit one of standard connector (SC), fiber channel (FC), MU, or Lucent connector (LC) assemblies.

3. The method according to claim 1, wherein said lens comprises a ball lens or a graded index (GRIN) lens.

4. The method according to claim 1, wherein each of said one or more connectors comprise a ferrule assembly that encompasses an end of said optical fiber and is at least partially within a stem assembly.

5. The method according to claim 4, wherein said ferrule assembly comprises zirconia.

6. The method according to claim 4, wherein said stem assembly comprises stainless steel.

7. The method according to claim 4, comprising aligning said plurality of fiber cores utilizing an alignment notch in said stem assembly.

8. The method according to claim 4, comprising fixing said lens adjacent to said ferrule assembly utilizing a stainless steel tube.

9. The method according to claim 1, comprising communicating said collimated optical signals to a receiving lens.

10. The method according to claim 9, comprising focusing said collimated optical signals onto a plurality of optical cores in a receiving optical fiber utilizing said receiving lens.

11. A system for communication, the system comprising:
an optical fiber comprising a plurality of fiber cores and one or more connectors, wherein optical signals are communicated in said plurality of fiber cores to said one or more connectors and said optical signals are collimated utilizing a lens in said one or more connectors.

12. The system according to claim 11, wherein said one or more connectors comprise dimensions to fit one of standard connector (SC), fiber channel (FC), MU, or Lucent connector (LC) assemblies.

13. The system according to claim 11, wherein said lens comprises a graded index (GRIN) lens or a ball lens.

14. The system according to claim 11, wherein each of said one or more connectors comprise a ferrule assembly that encompasses an end of said optical fiber and is at least partially within a stem assembly.

15. The system according to claim 14, wherein said ferrule assembly comprises zirconia.

16. The system according to claim 14, wherein said stem assembly comprises stainless steel.

17. The system according to claim 14, wherein said plurality of fiber cores is aligned utilizing an alignment notch in said stem assembly.

18. The system according to claim 14, wherein said lens is fixed adjacent to said ferrule assembly utilizing a stainless steel tube.

19. The system according to claim 11, wherein collimated optical signals are communicated to a receiving lens that focuses said collimated optical signals onto a plurality of optical cores in a receiving optical fiber.

20. A system for communication, the system comprising:
an optical fiber comprising a plurality of fiber cores and one or more connectors, wherein optical signals are communicated in said plurality of fiber cores to said one or more connectors and said optical signals are collimated utilizing a lens in said one or more connectors, and wherein said lens is fixed adjacent to a ferrule assembly utilizing a stainless steel tube.
